(19) United States
(12) Patent Application Publication
(10) Pub. No.: US 2004/0017914 A1
(43) Pub. Date: Jan. 29, 2004

(54) Information reproducing apparatus, information reproducing method, and information reproducing program, and information recording medium on which the information reproducing program is recorded

(75) Inventor: Kenichiro Tada, Tokorozawa-Shi (JP)

Correspondence Address: YOUNG & THOMPSON, 745 SOUTH 23RD STREET 2ND FLOOR, ARLINGTON, VA, 22202

(73) Assignee: PIONEER CORPORATION, TOKYO-TO (JP)

(21) Appl. No.: 10/614,829

(22) Filed: Jul. 9, 2003

(30) Foreign Application Priority Data
Jul. 29, 2002 (JP) 2002-220350

(51) Int. Cl. H04L 9/00; H04K 1/00

(52) U.S. Cl. 380/201; 705/59

(57) ABSTRACT

An information reproducing apparatus for reproducing record information from a hard disk drive on which the record information including pieces of enciphered material information having contents which are temporally parallel to each other is recorded, is provided with: a modem unit for obtaining deciphering information, set in each of the pieces of material information, for deciphering the pieces of enciphered material information; and a right management protection unit for deciphering the material information corresponding to the obtained deciphering information on the basis of the obtained deciphering information.

### BACKGROUND OF THE INVENTION

1. Field of the Invention

The present invention relates to the technical field of an information reproducing apparatus, an information reproducing method, an information reproducing program, and an information recording medium on which the information reproducing program is recorded and, more particularly, to the technical, field of an information reproducing apparatus, an information reproducing method, an information reproducing program for obtaining and reproducing broadcasted information including pieces of enciphered material information having contents which are temporally parallel to each other, and an information recording medium on which the information reproducing program is recorded.

2. Description of the Related Art

In recent years, a video such as a movie or music is distributed through a network such as the Internet, and, after the video or music are accumulated and stored in, e.g., a personal computer, the video or music can be audio-visually checked.

On the other hand, the distributed video or the like is frequently protected by so-called copyright. At this time, as the first example of the protecting method by the copyright, the following method is conventionally known. A enciphering process is performed to the video or the like to be distributed to distribute the video to a personal computer or the like serving as a distribution destination, and, at the same time, deciphering information (in general, frequently called a deciphering key) for deciphering the cipher obtained by the enciphering process is delivered to the same distribution destination for value without being leaked to the outside. At this distribution destination, the distributed video or the like is deciphered by using the delivered deciphering information to cause a user to audio-visually check.

As the second example of the protecting method, the following method is conventionally known. That is, when the enciphered video or the like is distributed after a distribution source and a distribution destination are authenticated with each other, deciphering information for deciphering a cipher obtained by the video or the like distributed in a period in which authentication is effective once is delivered for value without being leaked to the outside. At this distribution destination, the video or the like distributed in the effective-authentication period is deciphered by using the delivered deciphering information.

In these protecting methods, the video or the like which is enciphered and distributed is related to the deciphering information for deciphering the video or the like by the following manner. That is, in the first example, one piece of deciphering information is related to the whole of one video or the like (more specifically, one movie or the like). When the deciphering information can be obtained, the whole of the video or the like can be frequently deciphered. The-second example may have the following configuration. That is, one piece of deciphering information is related to the whole of a video or the like distributed in one effective-authentication period. When the deciphering information can be obtained, all videos or the like which are distributed in the effective-authentication period can be deciphered.

In addition, the whole of the video or the like is divided into a plurality of partial videos or the like on a time axis depending on the contents of the video, and one piece of deciphering information is related to each of the divided videos or the like. When the deciphered one partial video or the like is deciphered, the deciphering information corresponding to the partial video or the like may be obtained and used.

On the other hand, in recent years, the contents of the video or the like to be distributed may be distributed such that a plurality of videos or the like (the plurality of videos or the like are called pieces of material information in the following description) simultaneously corresponding to one story in parallel with each other are included in the video or the like. More specifically, for example, the video or the like corresponding to one movie may be distributed such that, in addition to main material information which looks down at the entire scene of the movie, the video material information constituted by a video or the like corresponding to a scene which is seen from the visual line of an actor taking part in the scene and material information constituted by a video or the like corresponding to the scene seen from the visual line of an actress taking part in the scene at the same time are included in the video or the like. At this time, the partial videos or the like on the time axis may be constituted by pieces of material information simultaneously corresponding to the partial videos or the like in parallel with each other, respectively.

However, in the conventional copyright protecting method described above, in any cases, only one piece of deciphering information is related to the whole of the distributed video or the like all the partial videos or the like which are divided on the time axis, and deciphering information is not related to each of the pieces of material information constituting the video or the like or the partial videos or the like.

In this case, when the pieces of material information include different pieces of caption information for captions of different languages corresponding to one movie, a user who audio-visually checks the movie must obtain deciphering information for deciphering the enciphered material information including a caption of another language even though she or he wants to watch a caption of, e.g., Japanese. In this case, the cost is disadvantageously twice the cost for obtaining only deciphering information for deciphering the enciphered material information including the caption in Japanese.

In the above example, since pieces of deciphering information for deciphering pieces of enciphered material information including captions corresponding to a plurality of different languages must be obtained at once, the following problem is posed. That is, the user cannot have an option to sequentially increase desired captions in number to enjoy movies to be distributed.

Therefore, the present invention has been made in consideration of the above problems, and has as its object to provide an information reproducing apparatus, an information reproducing method, and an information reproducing program which can inexpensively and efficiently obtain and reproduce a video or the like constituted by combining pieces of material information and distributed with good convenience, and an information recording medium on which the information reproducing program is recorded.

The above object of the present invention can be achieved by an information reproducing apparatus for reproducing record information from a recording unit such as a hard disk drive 15 etc., on which the record information including pieces of enciphered material information having contents which are temporally parallel to each other is recorded, provided with: an obtaining device such as a modem unit 8 etc., for obtaining deciphering information, set in each of the pieces of material information, for deciphering the pieces of enciphered material information; and a deciphering device such as a right management protection unit 9 etc., for deciphering the material information corresponding to the obtained deciphering information on the basis of the obtained deciphering information.

The above object of the present invention can be achieved by an information reproducing method for reproducing record information from a recording medium on which the record information including pieces of enciphered material information having contents which are temporally parallel to each other is recorded, provided with: an obtaining process of obtaining deciphering information, set in each of the pieces of material information, for deciphering the pieces of enciphered material information; and a deciphering process of deciphering the material information corresponding to the obtained deciphering information on the basis of the obtained deciphering information.

The above object of the present invention can be achieved by an information reproducing program wherein a computer included in an information reproducing apparatus for reproducing record information from a recording medium on which the record information including pieces of enciphered material information having contents which are temporally parallel to each other is recorded, is operated as: an obtaining device for obtaining deciphering information, set in each of the pieces of material information, for deciphering the pieces of enciphered material information; and a deciphering device for deciphering the material information corresponding to the obtained deciphering information on the basis of the obtained deciphering information.

The above object of the present invention can be achieved by an information recording medium wherein the above information reproducing program is recorded such that the information reproducing program can be read by a computer included in an information reproducing apparatus.

### BRIEF DESCRIPTION OF THE DRAWINGS

FIG. 1 is a diagram showing a logical format of AV information;

FIG. 2 is a block diagram showing a rough configuration of an information recording/reproducing apparatus according to an embodiment;

FIG. 3 is a flowchart showing a contents download process according to the embodiment;

FIG. 4 is a flowchart showing a license download process according to the embodiment;

FIG. 5 is a flowchart (I) showing a reproducing process according to the embodiment;

FIG. 6 is a flowchart (II) showing a reproducing process according to the embodiment;

FIG. 7 is a flowchart (III) showing a reproducing process according to the embodiment;

FIGS. 8A, 8B, and 8C are diagrams (I) illustrating display screens in the embodiment, in which FIG. 8A shows an example of a selection screen, FIG. 8B shows an example (i) of a thumbnail screen, and FIG. 8C shows an example (ii) of a thumbnail screen;

FIGS. 9A and 9B are diagrams (II) illustrating display screens in the embodiment, in which FIG. 9A is an example (iii) of a thumbnail screen and FIG. 9B is an example (iv) of a thumbnail screen;

FIGS. 10A and 10B are diagrams showing logical formats according to the first modification in which FIG. 10A is a diagram (i) showing the logical format and FIG. 10B is a diagram (ii) showing the logical format; and

FIGS. 11A and 11B are diagram showing logical formats according to the second modification in which FIG. 11A is a diagram (i) showing the logical format and FIG. 10B is a diagram (ii) showing the logical format.

### DESCRIPTION OF THE PREFERRED EMBODIMENT

A preferred embodiment of the present invention will be described below with reference to the accompanying drawings.

In the embodiment to be described later, the present invention is applied to an information recording/reproducing apparatus (to be described later) which can perform a recording process for recording AV information serving as the video or the like, i.e., AV (Audio Visual) information (including music information, video information, data information for data broadcasting, and the like) which is enciphered and distributed through a network such as the Internet on a hard disk in a hard disk drive which can be removed from the information recording/reproducing apparatus, which is portable, and which includes a protection chip subjected to a process for copyright protection, and a reproducing process for reproducing the recorded AV information from the hard disk.

In this case, the process for copyright protection in the protection chip is concretely called a process which can read information stored in the protection chip only when a predetermined specific read instruction is used.

In the following description, it is assumed that the AV information is distributed on the basis of the Transport Stream of the known MPEG-2 (Motion Picture Experts Group) standard which is standard related to a video compressing technique.

In addition, it is assumed that the AV information to be distributed includes the pieces of material information (the material information is appropriately called contents hereinafter), and it is assumed that the pieces of material information are independently enciphered and then distributed. At this time, since the AV information is distributed on the basis of the Transport Stream, each of the pieces of material information is divided into packets (to be referred to as so-called TS (Transport Stream) packets) serving as pieces of unit material information.

(I) Embodiment of Recording Format

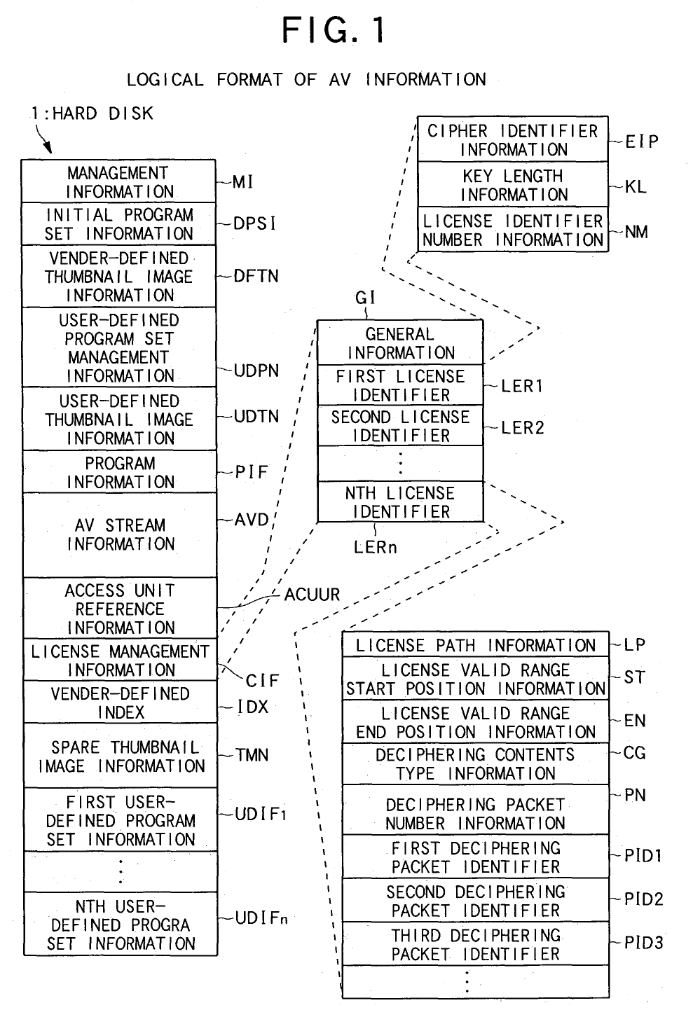

At first, before, the information recording/reproducing apparatus according to the embodiment is described, the outline of a logical recording format (to be simply referred to as a logical format hereinafter) used to record the AV information on the hard disk by the information recording/reproducing apparatus will be described below with reference to FIG. 1. FIG. 1 is a diagram which hierarchically and typically shows the logical format obtained after the AV information is recorded on the hard disk on the basis of the logical format.

As a physical recording format used when the AV information of the embodiment is recorded on the hard disk on the basis of the logical format, except for license management information CIF (to be described later) and license information (to be appropriately referred to as license information or the like), a known physical format used for the hard disk is directly used. The license information or the like is physically recorded in the protection chip.

The outline of various concepts which are employed in the recording format to manage the contents and recording modes of the recorded AV information will be described below.

Firstly, in the following recording format, as a unit for handling the AV information recorded on the hard disk, a concept of a “program” is used. More specifically, the program is one piece of AV information which has been continuously recorded.

In this case, when the distributed AV information is analog information, for example, when one TV program on television broadcasting is continuously recorded, the TV program serves as one TV program on the hard disk. When only some parts of the TV program are continuously recorded, only the continuously recorded parts serve as one TV program. Furthermore, when a plurality of TV programs are simultaneously and continuously recorded, all the plurality of recorded TV programs serve as one program. On the other hand, when the AV information is digital information, for example, when the AV information is distributed as a BS (Broadcast Satellite) digital broadcast, one so-called event in the BS digital broadcast is defined to be one program.

Secondly, in the following recording format, in order to cause a user (user who audio-visually checks recorded AV information) to flexibly edit temporarily recorded AV information to logically form a new program, a concept of a “program list” is used. More specifically, the program list is a list serving as a set of pieces of indicating information (in general, also called pointers) for specifying the whole or a part of one program to discriminate the whole or a part of the program from another program or another part. Typical images (to be referred to as thumbnail images hereinafter) typically showing the contents of AV information included in the program list can be defined for the program list.

Therefore, for example, when the user edits AV information such that a part of one recorded program and a part of another program are continuously reproduced in this order, the user herself/himself forms one program list by combining the programs such that indicating information indicating a part of the program and indicating information indicating a part of the other program are reproduced in this order. In addition, when the concept of the program list is employed, the AV information can be reproduced by a reproducing mode desired by the user without changing a recording order or the like in the AV information itself recorded on the hard disk at the start.

As the program lists, a program list (user-defined program list) which is set by a user herself/himself with reference to recorded AV information as described above and a program list (vender-defined program list) which is set in advance by a distributor (also called a vender or a provider) which distributes AV information to be recorded are defined.

Furthermore, the thumbnail images, a vender-defined thumbnail image which is set in advance by the vender and which is distributed together with the AV information and a user-defined thumbnail image which is newly set by the user after the distributed AV information is recorded on the hard disk.

Thirdly, in the following recording format, a concept of a “program set” which uses a set including a plurality of user-defined program lists and vender-defined program lists which are formed on the basis of a reproducing mode (more specifically, a reproducing order of AV information specified by a user or parts of the AV information) desired by a user is used. In this case, as program sets, an initial program set (a program list included in the initial program set is the vender-defined program list) used to reproduce pieces of AV information (programs) recorded on the hard disk at the start without changing the recording order of the pieces of AV information and a user-defined program set including the user-defined program list are defined.

Fourthly, in the following recording format, as one type of the indicating information, a concept of an “index” is used. More specifically, the index is indicating information which specifies the whole or a part of one program to discriminate the whole or the part of the program from another program or another part of the program, and is set to improve the facility for handling AV information by a user. At this time, as indexes, a vender-defined index which is set in advance by the distributor and then distributed and a user-defined index which is newly set by a user after distributed AV information is recorded on the hard disk are defined. The vender-defined index is distributed in a form of an index file together with the AV information. On the other hand, the user-defined index is expressed as the program list.

A logical recording format according to the embodiment will be described below on the basis of the various concepts described above.

As shown in FIG. 1, on a hard disk 1 on which necessary AV information is recorded, management information MI which is management information related to the whole of a program recorded on the hard disk 1 and which is referred to at the start when the recorded AV information is reproduced, initial program set information DPSI serving as management information related to the initial program set, vender-defined thumbnail image information DFTN which includes image information corresponding to the vender-defined thumbnail image such that the image information is specified by the name of the image information itself, user-defined program set management information UDPM serving as management information related to the user-defined program set, user-defined thumbnail image information UDTN which includes image information corresponding to the user-defined thumbnail image such that the image information is specified by the name of the image information itself, program information PIF serving as management information corresponding to each of the programs, AV stream information AVD which is the AV information itself distributed and recorded on the hard disk 1, access unit reference information ACUR including, in one access unit constituted by image information corresponding to one I-picture (Intra-enciphered Picture) included in the AV information, address information representing a recording position of the I-picture on the hard disk 1 and information representing a total amount of information of the I-picture in the access unit such that the pieces of information are separated into access units, license management information CIF serving as information for managing license states of pieces of material information in the recorded AV information, the vender-defined index IDX, a spare thumbnail image information TMN serving as image information corresponding to a spare image which is an image used as a thumbnail image and which is not any one of the vender-defined thumbnail image or the user-defined thumbnail image, and user-defined program set information UDIF1 to UDIFn serving as management information related to the user-defined program set (it is assumed in the case shown in FIG. 1 that there are n user-defined program sets) which is defined after the Ay information is recorded on the hard disk 1 are recorded.

As shown in FIG. 1, the license management information CIF according to the present invention is constituted by license identifiers LER1 to LERn which are license identifiers respectively corresponding to the pieces of material information (the pieces of material information are independently enciphered as described above) constituting the AV information recorded on the hard disk 1 to identify pieces of license information or the like (stored in the protection chip) used when the pieces of material information are independently deciphered, and management information GI for managing all the license identifiers LER.

In the case shown in FIG. 1, only n license identifiers of the license identifiers LER corresponding to the pieces of license information for deciphering the pieces of material information constituting the AV information recorded on the hard disk 1 are stored in the license management information CIF such that one license identifier LER corresponds to one piece of material information.

The pieces of license information are pieces of information serving as deciphering key used to decipher the pieces of material information recorded in an enciphering state when the pieces of material information are deciphered in reproduction. As will be described later, the pieces of license information are purchased and delivered independently of the AV information and stored in the protection chip.

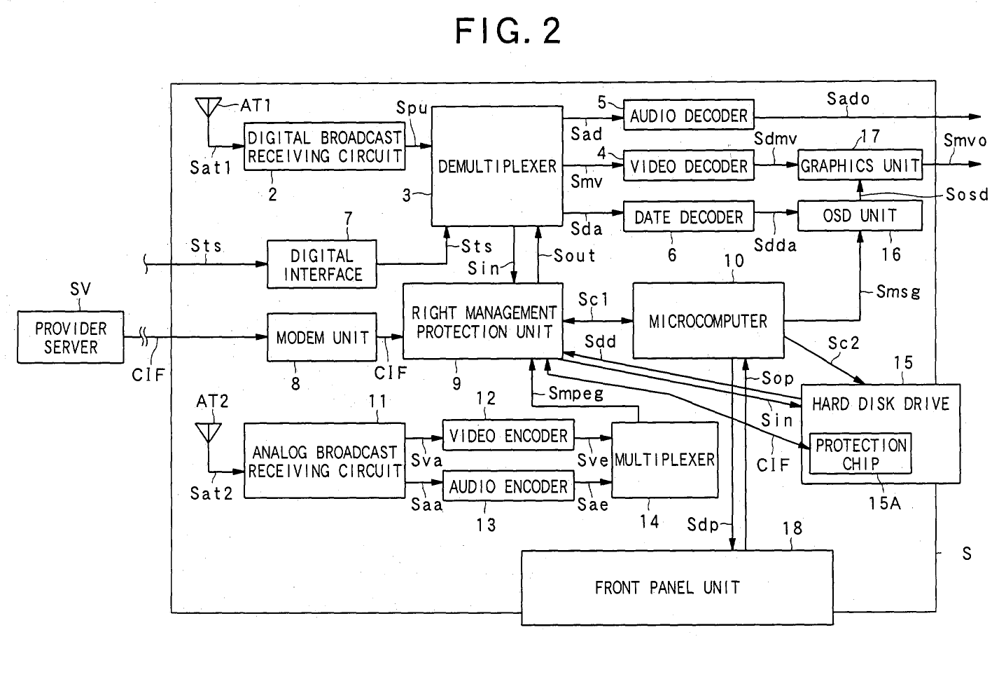

The details of the license identifiers LER and the management information GI will be described below with reference to FIG. 1. FIG. 2 is a diagram illustrating the configurations of the license identifier LER and the management information GI.

The detailed configurations of the management information GI and the license identifier LER will be described first.

As shown in FIG. 1, the management information GI is constituted by cipher identifier information EIP serving as an identifier representing the scheme of a enciphering process performed to the pieces of material information, key length information KL representing an amount of information of a deciphering key used when the deciphering the enciphering process, and license identifier number information NM representing the number of license identifiers LER managed by the management information GI.

One of the license identifiers LER is constituted by, as shown in FIG. 1, license path information LP including position information or the like representing a storage position of license information identified by the license identifier LER in the protection chip, license valid range start position information ST representing the start position of a region (a part of a region on the hard disk 1 on which the AV stream information AVD is recorded) on the hard disk 1 on which material information deciphered by using the license information, license valid range end position information EN representing the end position of a region on the hard disk 1 on which the material information deciphered by using the license information is recorded, deciphering contents type information CG representing the type of the material information deciphered by using the license information, deciphering packet number information PN representing the number of packets (TS packets) included in the material information deciphered by using the license information, and deciphering packet identifiers PID for identifying the packets included in the material information deciphered by using the license information.

(II) Embodiment of Information Recording/Reproducing Apparatus

The configuration and operation of an information recording/reproducing apparatus for performing recording/editing processes, for AV information depending on the logical format described above will be described below.

The entire configuration and the rough operation of the information recording/reproducing apparatus will be described first with reference to FIG. 2.

As shown in FIG. 2, an information recording/reproducing apparatus S according to this embodiment is constituted by antennas AT1 and AT2, a digital broadcast receiving unit 2, a demultiplexer 3, a video decoder 4, an audio decoder 5 serving as a reproducing device, a data decoder 6, a digital interface 7, a modem unit 8 serving as an obtaining device, a right management protection unit 9 serving as a deciphering device, a microcomputer 10, an analog broadcast receiving unit 11, a video encoder 12, an audio encoder 13, a multiplexer 14, a hard disk drive 15 serving as a recording unit including the protection chip 15A serving as a second recording medium, an OSD (On Screen Display) unit 16, a graphics unit The 17, and an operating front panel unit 18.

The operations of the information recording/reproducing apparatus S will be described below.

Operations of a recording process for recording the AV information input from the outside on the hard disk 1 serving as a first recording medium in the hard disk drive 15 will be described.

As the recording process, the antenna AT1 connected to the digital broadcast receiving unit 2 receives airwaves of a digital broadcast transmitted from a broadcasting station and generates a reception signal Sat1 corresponding to the received airwaves to output the reception signal Sat1 to the digital broadcast receiving unit 2.

In this manner, the digital broadcast receiving unit 2 extracts the reception signal Sat1 corresponding to a broadcast which is desirably received from the received reception signal Sat1, and outputs the reception signal Sat1 to the demultiplexer 3 as an extraction signal Spu. At this time, the extraction signal Spu includes enciphered material information constituting the AV information in such a form that the material information is divided into packets.

On the digital interface 7 receives transmission information Sts including the AV information and digitally transmitted from the outside through a cable, extracts transmission information Sts corresponding to a broadcast which is desirably received from the received transmission information Sts, and outputs the transmission information Sts to the demultiplexer 3. At this time, the transmission information Sts also include deciphered material information constituting the transmission information Sts in such a form that the material information is divided into packets.

In this manner, the demultiplexer 3 separates the pieces of enciphered material information included in the extraction signal Spu output from the digital broadcast receiving unit 2 and the transmission information Sts output from the digital interface 7 for the music information, the video information, the video information, and the data information, respectively, and records the pieces of material information as pieces of material information Sin for the pieces of information on the hard disk 1 in the hard disk drive 15 through the right management protection unit 9. At this time, the music information or the like included in the material information Sin is recorded as the AV stream information AVD shown in FIG. 1 to constitute the program described above.

On the other hand, the antennas AT1 and AT2 connected to the analog broadcast receiving unit 11 receives airwaves of an analog broadcast transmitted from a broadcasting station, and generates a reception signal Sat2 corresponding to the received airwaves to output the reception signal Sat2 to the analog broadcast receiving unit 11.

In this manner, the analog broadcast receiving unit 11 extracts a reception signal corresponding to a broadcast which is desirably received from the received reception signal Sat1, separates the extracted reception signal into analog audio information Saa including only audio information and analog image information Sva including both a video and audio information corresponding to the video, and outputs the analog audio information Saa and the analog image information Sva to the audio encoder 13 and the video encoder 12, respectively.

The audio encoder 13 enciphers the input analog audio information Saa depending on the MPEG-2 standard, generates coding audio information Sae, and outputs the coding audio information Sae to the multiplexer 14. The video encoder 12 enciphers the input analog image information Sva depending on the. MPEG-2 standard, generates coding image information Sve, and outputs the coding image information Sve to the multiplexer 14.

In this manner, the multiplexer 14 multiplexes the input coding audio information Sae and the coding image information Sve depending on the MPEG-2 standard, generates multiplexer information Smpeg, and outputs the multiplexer information Smpeg to the right management protection unit 9. At this time, the multiplexer information Smpeg includes material information (the multiplexer information Smpeg is frequently constituted by only one piece of material information when airwaves of an analog broadcast is received) constituting the multiplexer information Smpeg as packets in a form different from the form of the TS packet. On the stage of the multiplexer information Smpeg, since AV information is AV information which is obtained from an analog broadcast, the AV information is not enciphered.

The right management protection unit 9 enciphers the input multiplexer information Smpeg and records the enciphered multiplexer information Smpeg on the hard disk 1 in the hard disk drive 15 in the same manner as that of the material information Sin transmitted from the demultiplexer 3.

The modem unit 8 is connected to a provider server SV set in an external provider serving as an issue source of license information for deciphering the enciphered AV information (material information Sin) recorded on the hard disk 1 through a wire circuit, receives the license management information CIF transmitted from the provider server SV and the license information itself corresponding to the license management information CIF, and outputs the license management information CIF and the license information to the right management protection unit 9. The right management protection unit 9 stores the license management information CIF and the license information corresponding thereto in the protection chip 15A.

The license management information CIF obtained from the outside through the modem unit 8 and the license information corresponding to the license management information CIF are applied to only the AV information obtained through the digital broadcast receiving unit 2 or the digital interface 7. In contrast to this, the license management information CIF and the license information corresponding thereto which will be applied to the AV information obtained through the analog broadcast receiving unit 11 and which are uniquely generated by the right management protection unit 9 are stored in the protection chip ISA.

In the operations of the recording process, the microcomputer 10 uses control signals Sc1 and Sc2 to unify the right management protection unit 9 and the hard disk drive 15.

The input operation required for controlling the operations of the recording process is executed on the operating front panel unit 18, and an operation signal Sop corresponding to the input operation is generated and output to the microcomputer 10. The microcomputer 10 controls the series of operations of the recording process on the basis of the operation signal Sop.

In addition, presentation information to be shown to a user in the operations of the recording process is output as a display signal Sdp from the microcomputer 10 to the operating front panel unit 18. In this manner, the presentation information is shown to the user by using a display unit (not shown) or a loudspeaker or the like in the operating front panel unit 18.

Operations of a reproducing process for reproducing the AV information recorded on the hard disk 1 by the operations of the recording process described above in units of materials will be described below.

As the reproducing process, selection of AV information to be reproduced is executed by the operating front panel unit 18, an operation signal Sop corresponding to the AV information is generated and output to the microcomputer 10.

In this manner, the microcomputer 10 controls the hard disk drive 15 by using the control signal Sc2, detects desired pieces of AV information from the hard disk 1 for pieces of material information, and outputs the pieces of AV information as detection information Sdd to the right management protection unit 9. At this time, the pieces of material information are divided into packets, and the packets are output together with pieces of packet identification information, respectively.

In parallel with this, the microcomputer 10 extracts the license management information CIF corresponding to the AV information to be reproduced and license information corresponding thereto from the protection chip 15A and outputs the license management information CIF and the license information to the right management protection unit 9.

The right management protection unit 9, as will be described below, deciphers, ciphers performed to the material information including only packets which are permitted to be reproduced by the corresponding license management information CIF and the license information corresponding thereto of the packets constituting the detection information Sdd output from the hard disk drive 15, by using the license management information CIF and the license information corresponding thereto, and outputs the material information having the deciphered contents as output information Sout to the demultiplexer 3.

The demultiplexer 3 outputs material information constituted by only audio information of the pieces of material information included in the output information Sout output from the right management protection unit 9 as audio information Sad to the audio decoder 5, outputs material information constituted by video information and audio information corresponding thereto as video information Smv to the video decoder 4, and outputs material information constituted by only digital data for so-called data broadcasting except for the audio information and the video information as data information Sda to the data decoder 6.

The audio decoder 5 decodes the audio information Sad to generate deciphered audio information Sado and outputs the decoded audio information Sado to an external loudspeaker or the like (not shown).

The video decoder 4 decodes the video information Smv to generate decoded video image information Sdmv, and outputs the deciphered video image information Sdmv to the graphics unit 17.

The data decoder 6 decodes the data information Sda to generate decoded data information Sdda, and outputs the deciphered data information Sdda to the OSD unit 16.

On the other hand, when there is a message or the like (more specifically, for example, a message or the like for a warning display screen (to be described later)) constituted by character information which must be superposed on an image reproduced and displayed as the decoded video image information Sdmv, the message or the like is generated in the microcomputer 10 and output to the OSD unit 16 as message information Smsg.

In this manner, the OSD unit 16 superposes the message or the like on the image reproduced and displayed as the decoded video image information Sdmv as needed, generates display screen information Sosd corresponding to a display screen to be displayed as a reproduction result, and outputs the display screen information Sosd to the graphics unit 17.

The graphics unit 17 superposes the display screen corresponding to the display screen information Sosd on an image corresponding to the decoded video image information Sdmv, performs a process or the like for simultaneously displaying a plurality of images to generate a display signal Smvo, and outputs the display signal Smvo to an external monitor (not shown) to cause the monitor to display a video corresponding to the display signal Smvo.

In this case, an information exchange executed between the modem unit 8 and the external provider server SV and an information exchange executed between the right management protection unit 9 and the protection chip 15A will be described below in detail.

In the information exchange, a concept of a “session” is used. More specifically, an information exchange between the modem unit 8 and the external provider server SV or an information exchange between the right management protection unit 9 and the protection chip 15A is performed, immediately before the information exchanges are performed, a so-called authentication process in which devices are authenticated with each other as devices to be regularly connected to each other is executed. An information exchange which is made valid by performing the authentication process once corresponds to the session. In addition, pieces of authentication information (so-called session license) which are used in an authentication process for making sessions valid and which vary depending on the sessions are generated in the devices at any time and recognized.

In the following explanation, a session executed between the modem unit 8 and the provider server SV is called the first session, and a session executed between the right management protection unit 9 and the protection chip ISA is called the second session.

(A) Embodiment of Contents Download Process

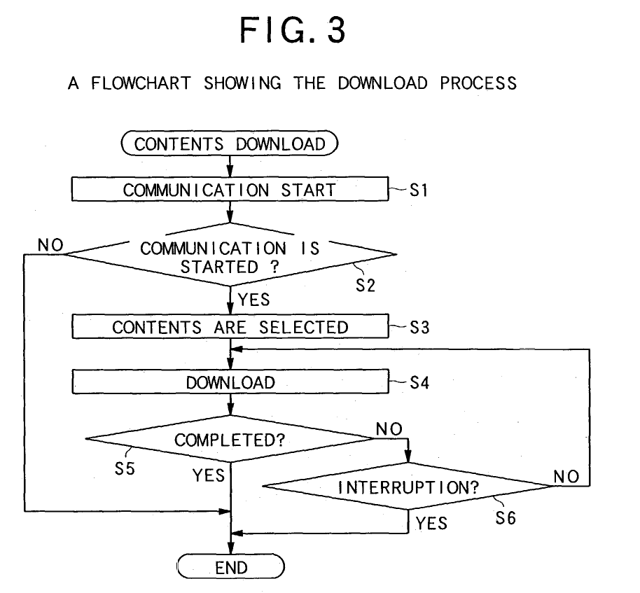

A contents download process according to the present invention executed in the information recording/reproducing apparatus having the above configuration and operations will be described below with reference to FIG. 3. As the download process (will be described later), a process performed when AV information including pieces of material information (to be appropriately referred to as contents hereinafter) to be recorded on the hard disk 1 is obtained through the digital broadcast receiving unit 2 and recorded on the hard disk 1 will be described below.

FIG. 3 is a flowchart showing the download process.

As shown in FIG. 3, in the download process, at the start, communication with a transmission source for a digital broadcast serving as a corresponding download source is started (steps S1 and S2). At this time, in the connection process, any authentication process similar to the session is not performed between the target broadcast source and the digital broadcast receiving unit 2, and the communication with each other is started.

When the communication is started (step S2; YES), contents desired by the broadcast source and the digital broadcast receiving unit 2 are selected (step S3). In addition, the selected contents (in this stage, the contents are enciphered) are output to the demultiplexer 3 through the digital broadcast receiving unit 2. Thereafter, in the demultiplexer 3, the respective contents (material information) are separated from each other and recorded on the hard disk 1 as the pieces of material information Sin in the hard disk drive 15 through the right management protection unit 9 (step S4). At this time, the recorded contents are transmitted and recorded such that the contents are divided into the packets. The packets are transmitted and recorded such that packet identification information is added to each packet to discriminate the corresponding packet from another packet.

On the other hand, when communication is not started in the determination in step S2 (step S2; NO), it is considered that the contents download process cannot be normally executed at the present, and the download process is immediately ended.

In the execution of the download process, it is always monitored whether a download process for desired contents are completed or not (step S5). When it is detected that the download process is completed (step S5; YES), the download process is immediately completed.

On the other hand, in the determination in step S5, when the download process for necessary contents is not completed (step 5; NO), it is checked whether a process for interrupting the download process is executed or not in the operating front panel unit 18 (step S6). When the process for interruption is performed (step S6; YES), the download process is immediately completed. On the other hand, when the process for interruption is not performed (step S6; NO), the microcomputer returns to the step S4 to continue the download process.

(B) Embodiment of License Download Process

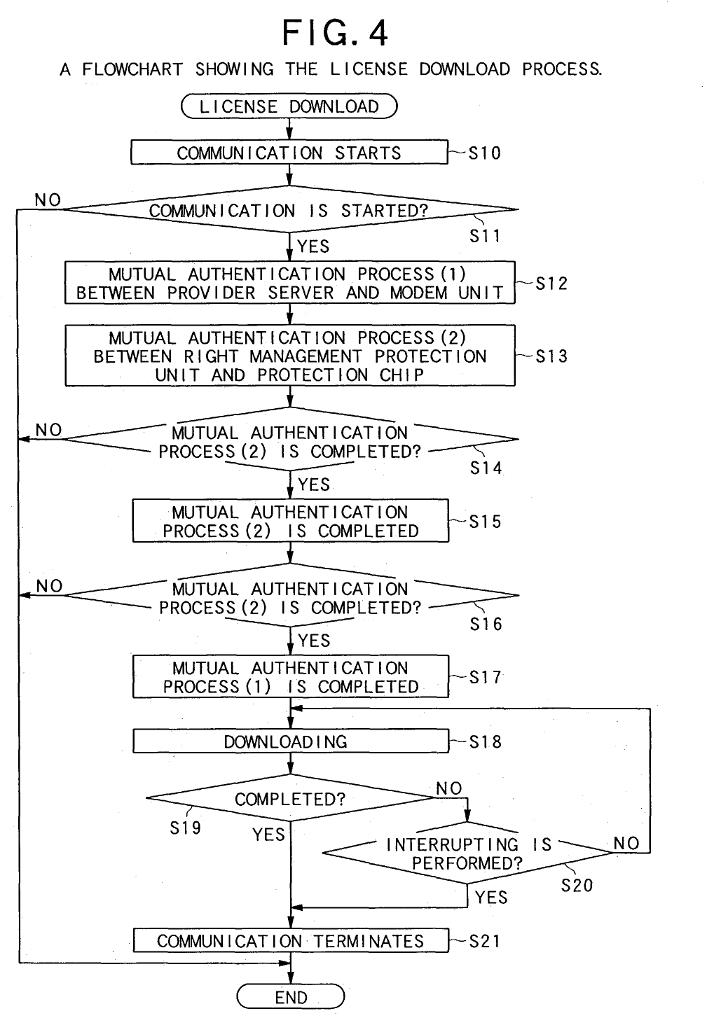

A license download process for obtaining license information for deciphering the ciphers of the contents enciphered and recorded on the hard disk 1 by the contents download process and license information or the like corresponding to the license information will be described below with reference to FIG. 4. FIG. 4 is a flowchart showing the license download process.

As shown in FIG. 4, in the license download process, at the beginning, communication between the provider server SV and the modem unit 8 is started (steps S10 and S11).

When the communication is not normally started for some reason (steps S11; NO), the license information or the like cannot be normally obtained without other operations, and the download process shown in FIG. 4 is immediately completed. On the other hand, when the communication is normally started (step S11; YES), a mutual authentication process required to obtain the license information or the like from the provider server SV is performed between the provider server SV and the modem unit 8 (step S12).

When the authentication process is executed to start the first session, a mutual authentication process required to mutually exchange the license information or the like between the right management protection unit 9 and the protection chip 15A is performed (step S13).

It is checked whether the mutual authentication process between the right management protection unit 9 and the protection chip 15A is completed or not (step S14). When the mutual authentication process is not normally completed (step S14; NO), it is considered that the security of the license information or the like cannot be achieved in the subsequent processes, the license download process is immediately ended. On the other hand, when the mutual authentication process is normally completed (step S14; YES), the second session between the right management protection unit 9 and the protection chip 15A is started (step S15).

When the second session is normally started, it is checked whether the mutual authentication process in step S12 is completed or not (step S16). When the mutual authentication process is not normally completed, it is considered that the security of the license information or the like cannot be achieved in the subsequent processes, and the license download process is immediately ended. On the other hand, when the mutual authentication process is normally completed (step S16; YES), the first session is started (step S17), a process for downloading necessary license information and the license management information CIF from the provider server SV is executed (step S18). At this time, the license information or the like subjected to the download process is stored in the protection chip 15A through the right management protection unit 9. In this case, the storage manner of the license management information CIF in the protection chip 15A is the same as that in the embodiment shown in FIG. 1.

In the execution of the download process, it is always monitored whether a download process for desired license information is completed or not (step S19). When it is detected that the download process is completed (step S19; YES), the first session and the second session are stopped to complete the download process.

On the other hand, when it is determined in step S19 that the download process for the necessary license information or the like is not completed (step S19; NO), it is checked whether a process for interrupting the download process is executed on the operating front panel unit 18 or not (step S20). When the process for interrupting the download process is performed (step S20; YES), the download process is immediately completed. On the other hand, the process for interrupting the download process is not performed (step S20; NO), the microcomputer returns to the step S18 to continue the download process.

(c) Embodiment of Reproducing Process

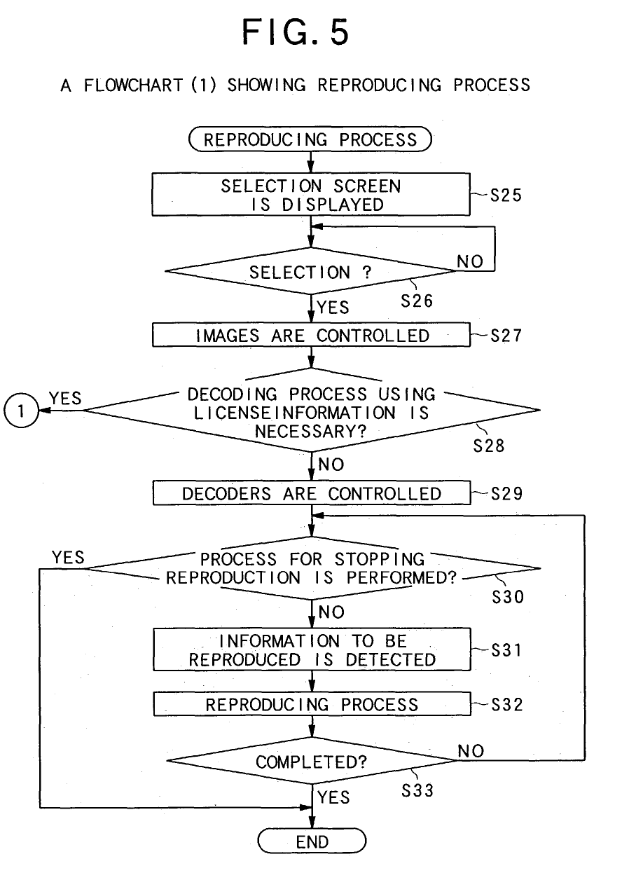

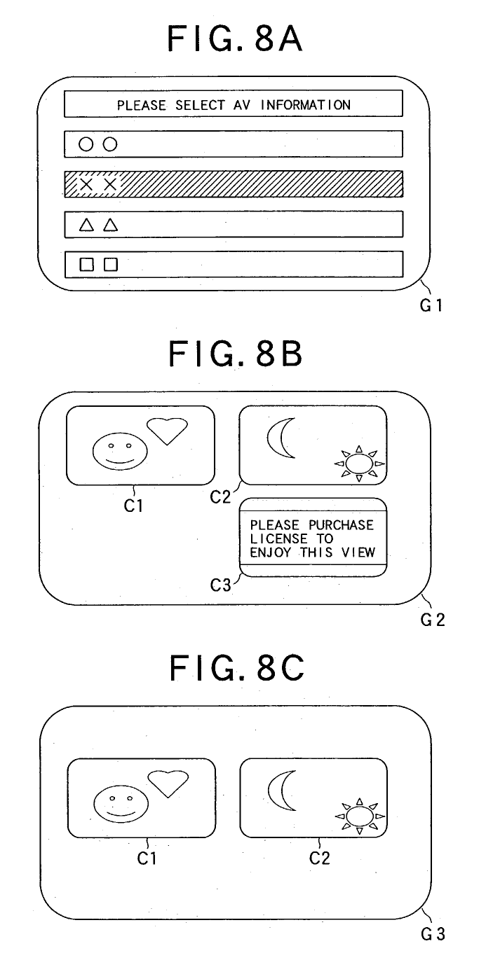

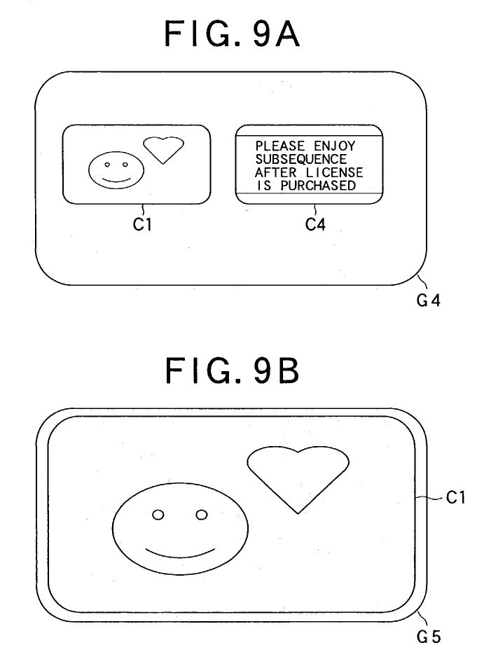

A reproducing process for reproducing the contents enciphered and recorded on the hard disk 1 by the contents download process while deciphering the contents by using the license information stored in the protection chip 15A by the license download process and the license management information CIF corresponding to the license information will be described below with reference to FIGS. 5 to 9. FIGS. 5 to 7 are flowcharts showing the reproducing process, and FIGS. 8 and 9 are diagram showing screens displayed on the monitor (not shown) in execution of the reproducing process, respectively.

As shown in FIG. 5, at the beginning in the reproducing process, an AV information selection screen G1 as shown in FIG. 8A is displayed on a monitor (not shown) by the functions of the microcomputer 10 the OSD unit 16 and the like (step S25). In this case, FIG. 8A shows that four pieces of AV information are recorded on the hard disk 1 at the present and that the second piece of AV information of the four pieces of AV information is selected. The AV information shown in FIG. 8A corresponds to AV information including the contents serving as material information in the explanation made up to this as “views” (for example, the AV information is one movie or the like, and FIG. 8A illustrates that a movie the title of which is “something or something” is recorded as AV information.

When the selection screen G1 is displayed, it is checked whether any piece of AV information is selected in the displayed selection screen G1 or not (step S26). When no AV information is selected (step S26; NO), the microcomputer is set in a standby state until any AV information is selected. On the other hand, when any AV information is selected (step S26; YES), for the respective views (i.e., the contents) constituting the selected AV information, the decoders or the like are controlled such that a plurality of thumbnail images corresponding to the views are simultaneously displayed on the monitor (step S27).

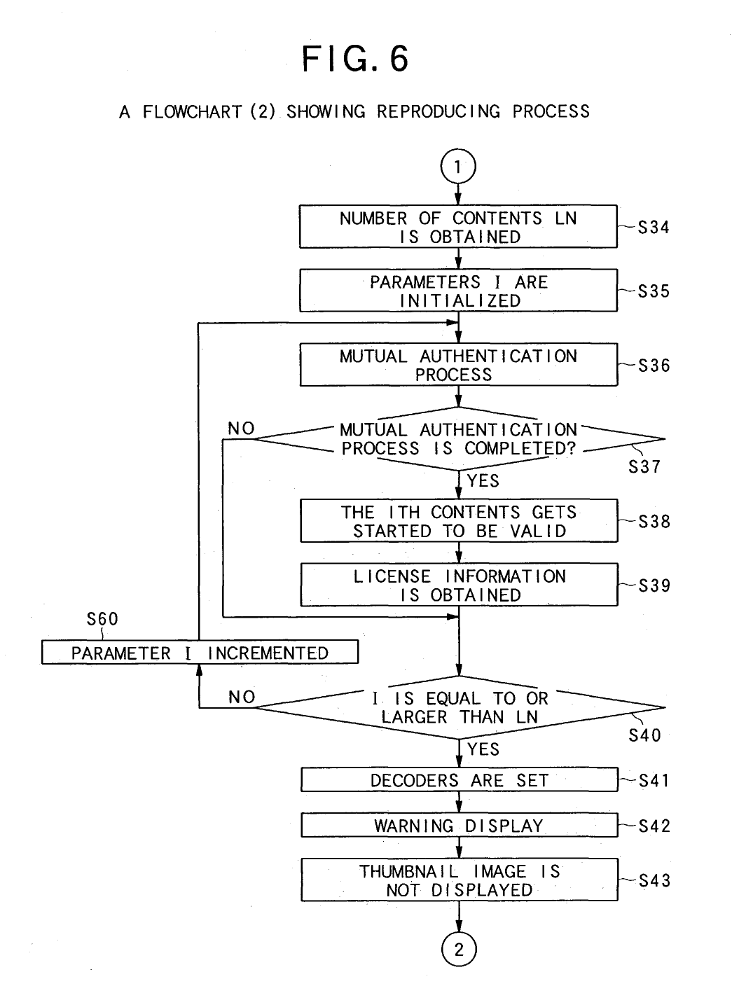

It is checked that the contents included in the selected AV information include contents which are necessarily subjected to a deciphering process using the license information or the like in the reproduction of the AV information or not (step S28). When the contents include the contents which are necessarily subjected to the deciphering process (step S28; YES), the microcomputer shifts to a process (will be described later by using FIG. 6). On the other hand, when any contents included in the selected AV information are not necessarily subjected to the deciphering process (that is, the selected AV information is not enciphered. step S28; NO), the decoders are controlled to decode the selected AV information (step S29).

It is checked whether the process for stopping reproduction is performed on the operating front panel unit 18 or not (step S30). When this process is performed (step S30; YES), the reproducing process of this embodiment is immediately ended. On the other hand, when the process for stopping reproduction is not performed (step S30; NO), the AV information to be reproduced is detected from the hard disk 1 (step S31), and the reproducing process is executed by using the decoders controlled as described above (step S32).

In the execution of the reproducing process, it is always monitored whether the AV information to be reproduced is entirely completed or not (step S33). When the reproducing process is completed (step S33; YES), the reproducing process according to the embodiment is immediately ended. On the other hand, the reproducing process is not completed (step S33; NO), the microcomputer returns to the step S30 to continue the necessary reproducing process.

In the determination in step S28, a process performed when the selected AV information includes the contents which are necessarily subjected to the deciphering process using the license information or the like in the reproduction (step S28; YES) will be described below with reference to FIG. 6.

When the deciphering process is necessary in the reproduction of the selected AV information, at the beginning, a parameter LN representing the number of contents, which are necessarily subjected to the deciphering process, of the contents included in the AV information are obtained from general information GI in the corresponding license management information CIF (step S34). In addition, parameters i representing the numbers of the contents which are necessarily subjected to the deciphering process are initialized (step S35).

As preparation for performing the second session for obtaining the license information or the like required to decipher the enciphered contents in the AV information to be reproduced, the mutual authentication process is performed between the right management protection unit 9 and the protection chip 15A (step S36) to check whether the mutual authentication process is normally completed or not (step S37). When the mutual authentication process is not normally completed (step S37; NO), the microcomputer immediately shifts to step S40 (to be described later). On the other hand, when the mutual authentication process is normally completed (step S37; YES), the second session of the ith contents corresponding to the license information is started to be valid to obtain license information or the like for deciphering the ith contents (step S38). Furthermore, in the second session, license information or the like for deciphering the ith contents is obtained from the protection chip 15A in the right management protection unit 9 (step S39).

It is checked whether the value of a present parameter i is equal to or larger than the obtained parameter LN or not (step 940). When the value of the parameter i is not equal to or larger than the parameter LN (step S40; NO), the parameter i incremented by “1” to obtain license information for deciphering the contents of the next number (step S60), and the processes subsequent to the process in step S36 are repeated on the basis of the incremented value.

On the other hand, in the determination in step S40, when the parameter i is equal to or larger than the parameter LN (step S40; YES), it is considered that necessary pieces of license information or the like the number of which is equal to the number of contents to be deciphered in the AV information to be reproduced at the present have been obtained. The decoders are set to decipher or decode the contents by using the obtained license information or the like (step S41). Furthermore, thumbnail images corresponding to the contents to be deciphered in the future are displayed on the monitor or the like on the basis of the setting.

When it is determined by the obtained license information or the like that the contents include contents which are not permitted to be deciphered at the present, a warning display corresponding to the contents which are not permitted to be deciphered is output onto the monitor by using the microcomputer 10, the OSD unit 16, and the like (step S42).

A warning display screen displayed in the step S42 will be illustrated by using FIG. 8B.

As a warning display screen G2 for the warning display, as shown in FIG. 8B, with respect to thumbnail images showing contents which are permitted to be deciphered, thumbnail images themselves are displayed like thumbnail images C1 and C2 in FIG. 8B. However, with respect to thumbnail images showing the contents which are not permitted to be deciphered, the thumbnail images themselves are not displayed, and, a message representing that another license information must be obtained by purchasing the license information to reproduce the contents is displayed by the functions of the microcomputer 10, the OSD unit 16, and the like, as shown as a thumbnail image C3 in FIG. 8B.

When the necessary warning display is executed, the thumbnail image representing the contents which are not permitted to be deciphered is not displayed in the entire display region (step 543), and an actual deciphering process or the like is started. At this time, as a screen displayed on the monitor in the step S43, for example, as indicated as a display screen G3, only the thumbnail images C1 and C2 showing decipherable contents are displayed.

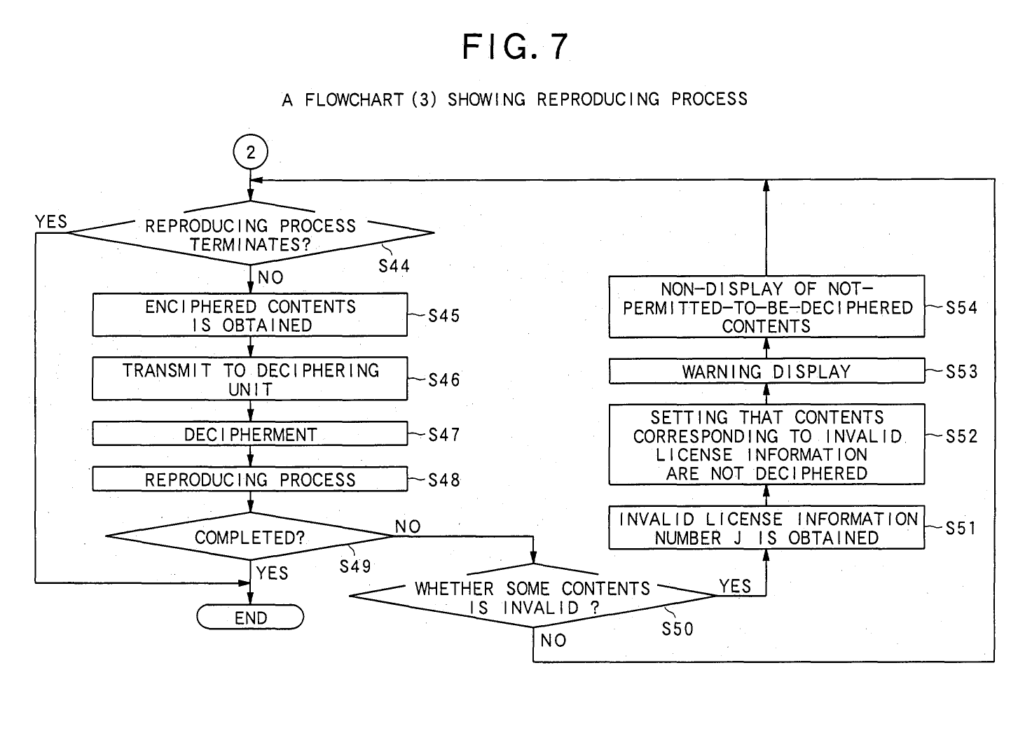

The details of the actual deciphering process will be described below with reference to FIG. 7.

In the deciphering process, as shown in FIG. 7, the microcomputer 10 checks whether an operation for stopping the reproducing process is executed in the operating front panel unit 18 or not (step S44). When the operation for stopping the reproducing process is performed (step S44; YES), the reproducing process is immediately ended.

On the other hand, in the determination in step S44, the operation for stopping the reproducing process is not performed (step S44; NO), AV information which is to be reproduced and which includes enciphered contents is obtained from the hard disk 1 (step S45), only packets which are permitted to be deciphered in the contents which are permitted to be deciphered by the ith license information or the like are selected by using the license management information CIF to transmit the packets to a deciphering unit (not shown) in the right management protection unit 9 (step S46). Furthermore, in the deciphering unit, the contents are deciphered in units of the packets transmitted by using the ith license information or the like (step S47).

The contents including the deciphered packets are decoded by using the decoders and output to the monitor or the loudspeaker to perform a reproducing process (step S48). At this time, in the reproducing process, it is always monitored whether all AV information to be reproduced is reproduced or not (step S49). When the reproducing process is completed (step S49; YES), the reproducing process according to the embodiment is immediately ended.

On the other hand, when all the reproducing processes are not completed (step S49; NO), on the basis of the obtained license information or the like, with the progresses of reproduction of the contents, it is determined whether some contents in which the license information or the like is invalid exist or not (step S50). That is, when it is determined whether the packets are permitted to be deciphered, it is determined whether or not the following contents and license information or the like exit or not. The contents and license information or the like are contents and license information or the like to be reproduced thereafter have not been permitted to be deciphered, whereas contents and license information or the like which have been reproduced are permitted to be deciphered.

When the invalid license information or the like does not exist in the determination in step S50 (step S50), the microcomputer continuously returns to the step S44 to continue the reproducing process.

On the other hand, in the determination in step S50, when invalid license information or the like exists (step S50; YES), a number j of the invalid license information or the like is obtained (step S51), and a setting that the contents corresponding to the ith license information or the like which is invalid are not deciphered is performed in each of the decoders (step S52).

A warning display representing that the invalid contents exist is output onto the monitor by using the microcomputer 10, the OSD unit 16, and the like (step S53).

A warning display screen displayed in the step S53 will be illustrated by using FIG. 9A.

As a warning display screen G4 for the warning display, as shown in FIG. 9A, with respect to thumbnail images showing contents which are permitted to be deciphered, thumbnail images themselves are displayed like thumbnail images C1. However, with respect to thumbnail images showing the contents which are not permitted to be deciphered, the thumbnail images themselves are not displayed, and, as shown a thumbnail image C4 in FIG. 9A, a message representing that another license information must be obtained by purchasing the license information to reproduce the contents is displayed by the functions of the microcomputer 10, the OSD unit 16, and the like.

When the necessary warning display is executed, the thumbnail image representing the contents which are not permitted to be deciphered is not displayed in the entire display region (step S54), and the microcomputer shifts to the process in the step S44. At this time, as a screen displayed on the monitor in the step S54, for example, as indicated a display screen G5 in FIG. 9B, only the thumbnail image C1 showing contents which can be continuously deciphered is displayed.

As described above, by the operation of the information recording/reproducing apparatus S according to the embodiment, the enciphered contents are deciphered and reproduced in units of contents by using pieces of license information or the like corresponding to the contents, respectively. For this reason, a user obtains only license information or the like for deciphering contents which are desired to be reproduced and records the license information or the like on the protection chip 15A, the user can select whether the desired enciphered contents are deciphered in units of contents or not, and the number of contents which are to be reproduced and which can be selected by the user can be increased, and AV information including the contents can be reproduced by efficiently using the cost required to obtain the license information or the like for reproducing the enciphered contents.

Since the contents are enciphered and then recorded, the contents and the AV information including the contents can be effectively prevented from being illegally obtained and illegally reproduced.

In addition, since enciphered packets constituting contents are deciphered in units of packets, it can be selected whether the enciphered packets in one set of contents can be deciphered in units of packets or not. Reproducing modes for AV information can be selected from a wide variety of modes.

(III) Modifications

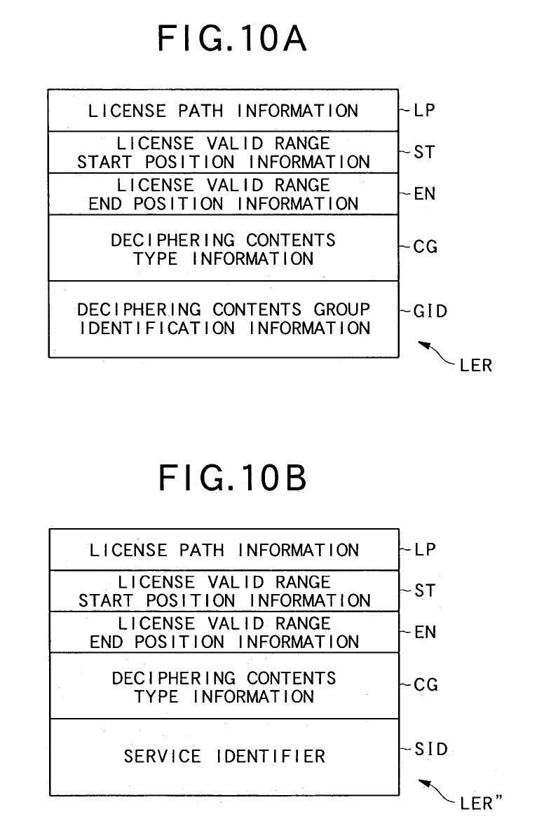

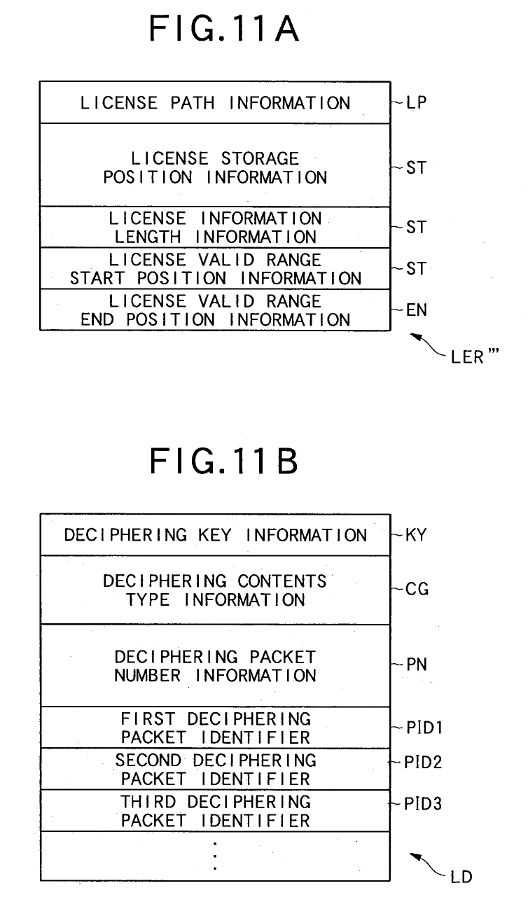

Modifications of the present invention will be described below with reference to FIGS. 10 and 11.

The first modification will be described below with reference to FIG. 10.

With respect to the forms of license identifiers described in FIG. 1, in addition to the license identifier LER in the embodiment, when packets to be deciphered by using one piece of license information or the like are recorded on the hard disk 1 as one group, a license identifier LER′ may be constituted to include identification information for identifying the group (in FIG. 10A, corresponding to a “deciphering contents group” serving as a unit material information group). In this case, like the license identifiers LER shown in FIG. 1, the license identifier LER′ includes license path information LP, license valid range start position information ST, license valid range end position information EN, and deciphering contents type information CG. Furthermore, the license identifier LER′ further include deciphering contents group identification information GID for identifying a group including packets to be deciphered by using the license information or the like.

When the license identifier LER of the embodiment and the packets deciphered by using one piece of license information or the like are included in one MPEG program or a plurality of MPEG programs included in the transport stream and recorded on the hard disk 1, a license identifier LER″ including identification information (called a service identifier (service ID) in a standard on which the transport stream must depend) for identifying the MPEG programs may be constituted. The MPEG program is different from the program described above and constituted by AV information on the hard disk 1, and is an MPEG program included in a transport stream serving as a format in distribution in advance.

In this case, like the license identifier LER shown in FIG. 1, the license identifier LER″ includes license path information LP, license valid range start position information ST, license valid range end position information EN, and deciphering contents type information CG. The license identifier LER″ further includes a service identifier SID serving as identification information for identifying an MPEG program deciphered by the license information or the like.

According to the first modification described above, when enciphered packets are deciphered in units of groups each constituted by a plurality of packets, it can be selected whether the packets can be deciphered in units of groups or not, a reduction in amount of information of the license information itself and selection of a reproducing mode of AV information from a wide variety of modes can be compatible.

When deciphering is performed in units of MPEG programs, it can be selected whether deciphering can be performed in units of MPEG programs. Contents to be deciphered can be selected in conformity to the mode of a broadcast of AV information.

The second modification will be described below with reference to FIG. 11.

The form of the license identifier described in FIG. 1 may be constituted such that deciphering packet identifiers PID in the license identifier LER according to the embodiment are included in the license information.

More specifically, a license identifier LER′″ which is used in place of the license identifier LER according to the embodiment shown in FIG. 1 is formed as shown in FIG. 11A and included in the license management information CIF. At this time, like the license identifier LER, the license identifier LER′″ includes license path information LP, license valid range start position information ST, and license valid range end position information EN. The license identifier LER′″ further includes license storage position information LDST representing a storage position of the license information including the license identifier LER′″ on the hard disk 1 and license information length information LDL representing an amount of information of the license information.

The license information itself used in this case includes, as indicated by license information LD in FIG. 11B, deciphering key information KY serving as the main body of the license information LD and used to decipher enciphered contents. Furthermore the license information includes deciphering contents type information CG and deciphering packet number information PN, which are used in the license identifier LER of the embodiment, and deciphering packet identifiers PID for identifying packets included in contents deciphered by using the deciphering key information KY.

As described above, according to the second modification, since the deciphering packet identifier PID itself representing a packet to be deciphered is enciphered and recorded, contents in AV information can be more effectively prevented from being illegally obtained and illegally reproduced.

In the second modification described above, in place of the deciphering packet identifiers PID, the same deciphering contents group identification information GID or the same service identifier SID as that in the first modification may be included in the license information LD.

In the embodiment and the modifications, the license information is valid regardless of elapsed time after the license information or the like is stored in the protection chip 15A once. In addition, for example, the license information or the like is made valid in only a predetermined period which is set after the license information or the like is stored in the protection chip 15A, all the license information may be made invalid (i.e., it is set to be impossible to decipher all enciphered contents).

Furthermore, the validity/invalidity of the license information or the like is not determined by a period, and the following configuration may also be used. That is, after the deciphering/reproducing process is performed a predetermined number of times, depending on the number of times of the deciphering/reproducing process for target contents, all the license information or the like used to decipher the contents can be made invalid.

A program corresponding to the flowcharts shown in FIGS. 3 to 7 is recorded on a flexible disk in advance or obtained and recorded through a network such as the Internet, and the program is read and executed by a general-purpose microcomputer or the like, so that the general-purpose microcomputer or the like can also be operated as the microcomputer 10 according to the embodiment.

As described above in the embodiment and the modifications, in the operations of the information recording/reproducing apparatuses according to the embodiment and the modifications, pieces of license information or the like corresponding to contents are obtained, and the enciphered contents are deciphered and reproduced by using the pieces of license information or the like. For this reason, when a user obtains only license information or the like for deciphering contents which is desired to be deciphered and records the license information or the like on a protection chip. In this manner, it can be selected whether the enciphered contents are deciphered in units of contents desired by the user. For this reason, contents to be reproduced by the user can be selected from a wide variety of contents, and AV information including the contents can be reproduced by effectively using the cost required to obtain license information or the like for reproducing the enciphered contents.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2002-220350 filed on Jul. 29, 2002 including the specification, claims, drawings and summary is incorporated herein by reference in its entirety.

What is claimed is:

1. An information reproducing apparatus for reproducing record information from a recording unit on which the record information including pieces of enciphered material information having contents which are temporally parallel to each other is recorded, comprising:
an obtaining device for obtaining deciphering information, set in each of the pieces of material information, for deciphering the pieces of enciphered material information; and
a deciphering device for deciphering the material information corresponding to the obtained deciphering information on the basis of the obtained deciphering information.

2. The information reproducing apparatus according to claim 1, wherein
the material information is constituted by pieces of unit material information each having a predetermined amount of information, and
the deciphering information includes license information and identification information for identifying the pieces of unit material information which can be deciphered by the license information.

3. The information reproducing apparatus according to claim 1, wherein
the material information is constituted by a unit material information group constituted by pieces of unit material information each having a predetermined amount of information, and
the deciphering information includes license information and identification information for identifying the unit material information group which can be deciphered by the license information.

4. The information reproducing apparatus according to claim 1, wherein
the deciphering information includes license information and identification information for identifying the material information which can be deciphered by the license information.

5. The information reproducing apparatus according to claim 2, wherein
the recording unit includes a first recording medium which records the record information and a second recording medium which records the license information such that the license information is prevented from being illegally used, and
the deciphering information further includes position information representing a recording position of the license information in the second recording medium.

6. The information reproducing apparatus according to claim 5, wherein
the position information is enciphered and recorded in the recording unit, and position information deciphering information for deciphering the position information is recorded on the second recording medium, and
the obtaining device deciphers the position information on the basis of the position information deciphering information and obtains the license information from the second recording medium on the basis of the deciphered position information.

7. An information reproducing method for reproducing record information from a recording medium on which the record information including pieces of enciphered material information having contents which are temporally parallel to each other is recorded, comprising:
an obtaining process of obtaining deciphering information, set in each of the pieces of material information, for deciphering the pieces of enciphered material information; and
a deciphering process of deciphering the material information corresponding to the obtained deciphering information on the basis of the obtained deciphering information.

8. An information reproducing program wherein
a computer included in an information reproducing apparatus for reproducing record information from a recording medium on which the record information including pieces of enciphered material information having contents which are temporally parallel to each other is recorded, is operated as
an obtaining device for obtaining deciphering information, set in each of the pieces of material information, for deciphering the pieces of enciphered material information; and
a deciphering device for deciphering the material information corresponding to the obtained deciphering information on the basis of the obtained deciphering information.

9. An information recording medium wherein
the information reproducing program according to claim 8 is recorded such that the information reproducing program can be read by a computer included in an information reproducing apparatus.
